(19) United States
(12) Patent Application Publication
(10) Pub. No.: US 2003/0237003 A1
(43) Pub. Date: Dec. 25, 2003

(54) Method and apparatus for recovering from the failure or reset of an IKE node

(76) Inventors: Jaakko Rautiainen, Oulu (FI); Thomas Bergenwall, Espoo (FI)

Correspondence Address: ERICSSON INC., 6300 LEGACY DRIVE, M/S EVW2-C-2, PLANO, TX, 75024, US

(21) Appl. No.: 10/448,007

(22) Filed: May 29, 2003

(30) Foreign Application Priority Data
May 30, 2002 (GB) 0212444.4

(51) Int. Cl. H04L 9/00; G06F 15/16

(52) U.S. Cl. 713/201; 709/230; 713/150

(57) ABSTRACT

Methods and apparatus adapted to recover from the reset of an Internet Key Exchange (IKE) node involved in secure IPSec communication with one or more peer IKE nodes. For each phase 1 Security Association (SA) established prior to reset, an Internet Security Association and Key Management Protocol (ISAKMP) phase 1 SA delete message is generated. Each delete message is transmitted to the one or more peer IKE nodes, whereby the peer IKE nodes delete each local phase 1 SA corresponding to each of the phase 1 SAs established prior to the reset.

### CLAIM OF PRIORITY UNDER 35 USC 119

Priority is hereby claimed under 35 USC 119 to United Kingdom application serial no. GB 0212444-4 filed on May 30, 2002.

### FIELD OF THE INVENTION

The present invention relates to a method and apparatus for recovering from the failure and/or reset of an Internet Key Exchange (IKE) node involved in a secure communication with one or more peer IKE nodes.

### BACKGROUND TO THE INVENTION

There is an ever increasing demand for mobility in communications systems. However, this demand must be met in a manner which provides for the secure transfer of data between communicating parties. A concept known as Virtual Private Network (VPN) has recently been introduced with the aim of satisfying, by a combination of encryption and secure access, this demand. A VPN may involve one or more corporate Local Area Networks (LANs) or Intranets, as well as users coupled to “foreign” LANs, the Internet, wireless mobile networks, etc. An Internet Engineering Task Force (IETF) “standard” known as IP Security Protocol (IPSec) has been defined and provides for the creation of a secure connection between parties in a VPN over Internet Protocol Version 6 (IPv6).

Establishment of secure connections using IPSec is a two step procedure. The first step involves the IKE protocol (RFC2409) and, more specifically, the Internet Security Association and Key Management Protocol (ISAKMP), which is used by IKE to negotiate a so-called phase 1 Security Association (SA) between peer IKE nodes (e.g., a mobile terminal and a security gateway of a corporate LAN). According to RFC2408, a SA is a security protocol-specific set of parameters that completely defines the services and mechanisms necessary to protect traffic at that security protocol location. These parameters can include algorithm identifiers, modes, cryptographic keys, etc. One or more underlying pairs of phase 2 SAs (IPSec SAs) are established for the purpose of protecting actual user data traffic. Each phase 1 and 2 SA has associated with it Finite State Machines (FSMs) and contexts. For example, a crypto context contains the set of data which is needed to implement all of the cryptographic functions (encrypt, decrypt, sign digests, etc). If the AES or 3DES algorithm is used, the crypto context would comprise a secret key and an Initialisation Vector (IV). An example of a finite state machine would be that used to implement the IKE protocol.

A security gateway implementing IPSec comprises a central processing unit (CPU) which contains a Security Association Database (SAD) comprising all of the currently non-expired SAs relevant for communication with the VPN. Access to the VPN is controlled on the basis of the SAs in the SAD. In the event of a resetting of the security gateway, all SAs can be lost. The contexts and FSM states will also be lost. Typically, there may be of the order of 300 such SAs and these will need to be renegotiated when the security gateway is operational again, and new contexts and FSMs established, so as to re-establish secure communications. In the intervening period, a remote IKE peer may attempt to establish a phase 2 SA based on a phase 1 SA lost due to reset of the security gateway. The Internet Engineering task Force (IETF) provides some specifications for restoring operation following such a failure and loss of the SAD, but these techniques require a substantial amount of time before secure communication can be restored.

One possible solution is to copy the SAD to an area of non-volatile memory, periodically updating the SAD to include new SA data. FSM states and contexts must also be copied to the non-volatile memory. Following the reset of an IKE peer node, the SAD must be copied from the non-volatile memory to the working cache of the security gateway, and FSM states and contexts must be rebuilt using the recovered data. A problem with this approach is that full recovery (for hundreds or even thousands of SAs) will take a considerable amount of time. In addition, saving the SAD and the FSM and context data will require a considerable amount of non-volatile memory (approximately 2KBytes per SA). Much of this effort may be wasted if not all of the re-established SAs are actually required.

Accordingly, there is a need in the art for improved methods and apparatus for recovering from the reset of an Internet Key Exchange (IKE) node involved in secure IPSec communication with one or more peer IKE nodes; preferably, such improved methods can be easily implemented in the architecture of existing apparatus.

### SUMMARY OF THE INVENTION

To address the above-discussed deficiencies of the prior art, the present invention provides a method of recovering from the reset of an Internet Key Exchange (IKE) node involved in secure IPSec communication with one or more peer IKE nodes, the method comprising for each phase 1 Security Association (SA) established prior to reset, generating an ISAKMP phase 1 SA delete message using SA data and transmitting the delete message to the peer IKE node, which peer IKE node responds to the delete message by deleting the corresponding phase 1 SA.

Embodiments of the present invention result in the automatic deletion of all phase 1 SAs following reset of an IKE node. The deletion of phase 2 SAs underneath these phase 1 SAs might follow automatically or at least after phase 2 SAs have timed out or the byte count exceeded. Deletion of a SA is a much quicker procedure than the rebuilding of that SA, and also the volume of data required to delete an SA is much less than that required to rebuild an SA. Less data needs therefore to be saved to the non-volatile memory.

In an embodiment of the present invention, said ISAKMP Delete messages are generating following reset of the IKE node, using SA data stored in a non-volatile memory prior to reset. Alternatively, the Delete messages may be generated prior to reset, and stored in non-volatile memory for use following reset.

Preferably, the IKE node is arranged to periodically back-up SA data in a non-volatile memory such that the SA data is available to the IKE node following reset. More preferably, only phase 1 SA data and not phase 2 SA data is backed-up in order to reduce the storage requirements of the non-volatile memory. It is also not necessary to back up all FSM states and context data, needed to implement Sas; only certain crypto context data may be required in order to generate the ISAKMP delete messages.

In one embodiment of the present invention, the IKE node which is reset is a security gateway of a Virtual Private Network (VPN). The peer IKE nodes with which secure communication links are established may be fixed or mobile nodes associated with the VPN. In another embodiment of the present invention, the IKE node which is reset is a node within a mobile telecommunications network and said peer IKE nodes are mobile terminals.

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form.

### BRIEF DESCRIPTION OF THE DRAWINGS

FIG. 1 is a block diagram illustrating schematically a virtual private network including a security gateway;

FIG. 2 is a flow diagram illustrating a back-up mechanism implemented in the security gateway of FIG. 1; and

FIG. 3 is a flow diagram illustrating the operation of the security gateway of FIG. 1 vis-à-vis the handling of the reset of the gateway.

### DETAILED DESCRIPTION OF A PREFERRED EMBODIMENT

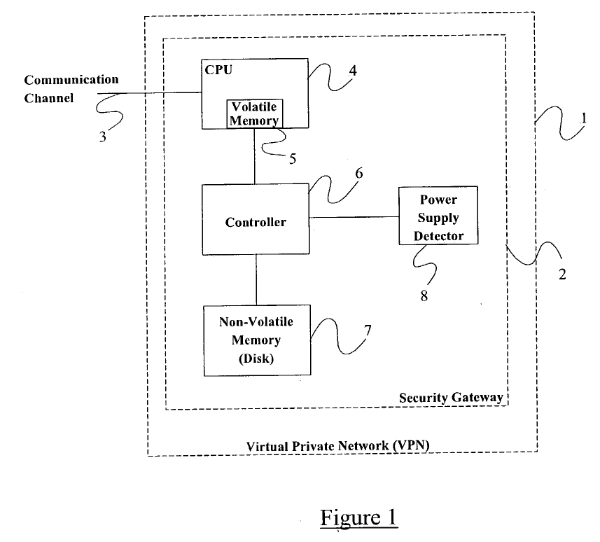

FIG. 1 illustrates a Virtual Private Network (VPN) 1 which includes a security gateway 2 for controlling external access to the VPN through a communication channel 3. For example, the channel 3 may be connected to a public network including one or more wireless terminals for providing mobile communication with mobile users.

The security gateway 2 comprises a central processing unit (CPU) 4 in the form of one or more programmable data processors controlled by a stored program. The CPU 4 includes a volatile memory 5, for example in the form of random access memory (RAM), for storing temporary values generated during operation of the CPU 4 in accordance with normal programmed data processor or computer techniques. During normal operation of the security gateway 2, the volatile memory contains, among other things, a security association database (SAD) in the form of a plurality of security associations (SAs). For example, each SA may comprise a header sequence number, encryption and authentication algorithms and parameters, and lifetime information for the SA. As explained above, phase 1 SAs are first negotiated between IKE peers, with phase 2 SAs then being negotiated using the already established phase 1 SAs. Associated with each SA is one or more Finite State Machines (FSMs) and one or more contexts. The security gateway 2 controls communication between external or mobile users and the VPN 1 in accordance with the pre-negotiated SAs and using the established FSMs and contexts in a manner which is known and which will therefore not be described further.

The security gateway 2 comprises a controller 6 for controlling read and write operations between the CPU 4 and a disk memory 7. The controller 6 is preferably in the form of a secure processor which cannot be removed from its circuit board without being damaged and which cannot be used or read by an attacker. Thus, even if an attacker gains illegal access to the security gateway and particularly to the controller 6, this will not assist in “hacking” into the system. The disk memory 7 may, alternatively, be replaced by any non-volatile read/write memory, such as a random access memory arrangement provided with an uninterruptible power supply.

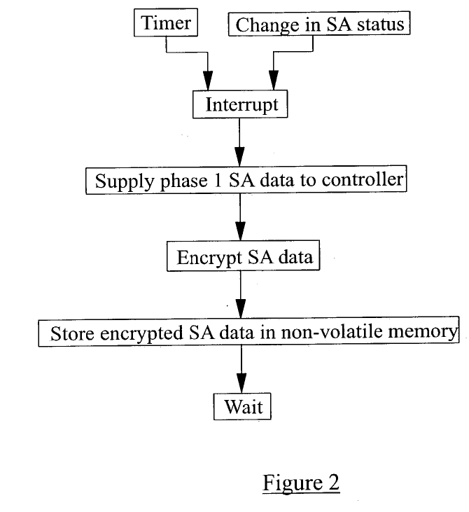

During normal operation of the security gateway 2, illustrated in FIG. 2, the current phase 1 SA data contained in the security association database in the volatile memory 5 is periodically stored in the disk memory 7 by the controller 6. A timer periodically supplies a pulse to initiate SA storage. For example, the timer may actuate a storage cycle three times in each fifteen minute interval. Alternatively or additionally, a change in the SA data may initiate a storage cycle. As well as backing up the phase 1 SA data, certain context data, associated with the phase 1 SAs, is also saved in the non-volatile memory.

In response to receipt of a signal for initiating a storage cycle, an interrupt is generated, for example for a data processor within the controller 6. The controller 6 accesses the volatile memory 5, either directly or via the data processors of the CPU 4, which supplies the required phase 1 SA and associated context data to the controller 6. The controller 6 encrypts the received data with a previously generated public key and stores the encrypted data in the disk memory 7. The controller 6 then enters a wait mode until a further interrupt is received. The total amount of data which is saved in the non-volatile memory for each phase 1 SA is of the order of 1 Kbyte.

The controller 6 is connected to a power supply detector 8 that detects whether or not power is supplied to the security gateway 2. In particular, the detector 8 detects the restoration of power following the switching off of the power supply to the security gateway 2. In the event of a reset of the power supply to the security gateway 2 (or possibly certain other failures), the contents of the volatile memory 5 are erased or corrupted so that the current SAD is lost. When power is restored and the security gateway 2 is operative again, the power supply detector 8 supplies a signal to generate another interrupt for the data processor of the controller 6. The controller 6 retrieves the most recently stored phase 1 SA and context data from the disk memory 7 and decrypts the data using the latest private key which, for example, may be stored in the disk memory 7 in association with the SA and context data.

The controller 6 then scans the SA data to identify each non-expired phase 1 SA. For each such SA, the controller causes an ISAKMP Delete message (RFC2408, chapters 4.8, 5.11 and 5.15) to be generated and sent to the peer IKE node identified in the SA. More specifically, the reset IKE node does the following:

1. Determines the DOI for this deletion;

2. Determines the Protocol-ID for this deletion;

3. Determines the SPI size based on the protocol ID field;

4. Determines the number of SPIs to be deleted for this protocol;

5. Determines the SPIs which is/are associated with this deletion;

6. Constructs a Delete payload; and

7. Transmits the Delete message to the peer IKE node.

An exemplary ISAKMP Delete message has the following structure:

Internet Security Association and Key Management Protocol

Initiator cookie
Responder cookie
Next payload: Hash (8)
Version: 1.0
Exchange type: Informational (5)
Flags

.... ...0 = No encryption
.... ..0. = No commit
.... .0.. = No authentication

Message ID: 0xe3fd0b24
Length: 80
Hash payload

Next payload: Delete (12)
Length: 24
Hash Data

Delete payload

Next payload: NONE (0)
Length: 28
Domain of Interpretation: IPSEC (1)
Protocol ID: ISAKMP (1)
SPI size: 16
Number of SPIs: 1
SPI (0).

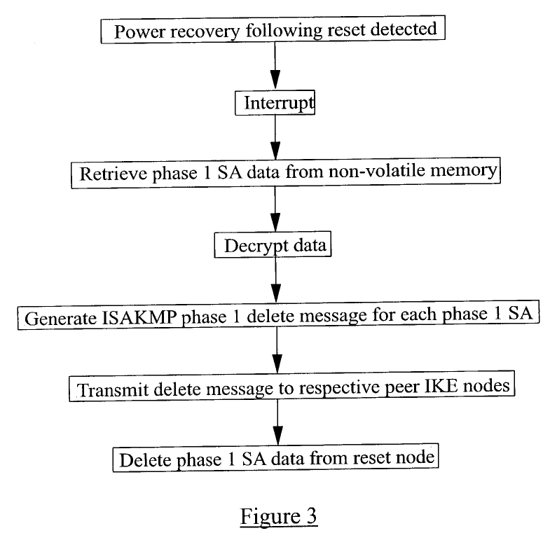

The receiving peer node responds to receipt of the Delete message by deleting the identified phase 1 SA from its SAD. The phase 2 SAs associated with the deleted phase 1 SA are automatically deleted (or deleted after the phase 2 SAs have timed out or the byte count exceeded). At the end of this process, all of the “old” phase 1 SA data is deleted from the reset IKE node. Whenever secure communication involving the reset IKE node and a peer IKE node is required, a new phase 1 IKE is negotiated. Whilst the traffic associated with the phase 1 SA deletion procedure is relatively light, significantly more traffic is associated with the establishment of new phase 1 SAs. However, this traffic will tend to be spread over time (not all phase 1 SAs will require establishment immediately), and in any case not all deleted phase 1 SAs will need to be replaced. This reset recovery procedure is illustrated in FIG. 3.

It will be appreciated by the person of skill in the art that various modifications may be made to the above described embodiment without departing from the scope of the present invention. For example, rather than generate the ISAKMP Delete message following reset of the security gateway, the message may be generated at the same time that the phase 1 SA data is saved to the non-volatile memory. The generated messages are then saved with the SA data, and are available to the controller following reset. This approach avoids the need to save context data in the non-volatile memory.

From the foregoing, those skilled in the art will recognize that the present invention provides improved methods and apparatus for limiting congestion in a packet-based network, particularly for controlling the transmission of voice traffic. Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be limited only by the claims recited hereinafter, and their equivalents.

What is claimed is:

1. A method of recovering from the reset of an Internet Key Exchange (IKE) node involved in secure IPSec communication with one or more peer IKE nodes, the method comprising the steps of:
for each phase 1 Security Association (SA) established prior to said reset, generating an Internet Security Association and Key Management Protocol (ISAKMP) phase 1 SA delete message; and
transmitting said delete message to said one or more peer IKE nodes, whereby said peer IKE nodes delete each local phase 1 SA corresponding to each of said phase 1 SAs established prior to said reset.

2. The method recited in claim 1, wherein each of said ISAKMP delete messages is generated following said reset of said IKE node using SA data stored in a non-volatile memory prior to said reset.

3. The method recited in claim 1, wherein each of said ISAKMP delete messages is generated prior to said reset, and are stored in non-volatile memory for use following said reset.

4. The method recited in claim 1, further comprising the step of:
periodically backing-up said phase 1 SA data in a non-volatile memory whereby said SA data is available to said IKE node following said reset.

5. The method recited in claim 4, wherein a crypto context for each phase 1 SA is also saved in said non-volatile memory.

6. The method recited in claim 1, wherein said IKE node is a security gateway of a Virtual Private Network (VPN).

7. The method recited in claim 1, wherein said IKE node is a node within a mobile telecommunications network and said peer IKE nodes are mobile terminals.

8. A communications node adapted to use the Internet Key Exchange (IKE) protocol to establish secure IPSec based communications with one or more peer IKE nodes, said node comprising:
a non-volatile memory; and
means for recovering from the reset of said node, said means including:
i) means for generating an Internet Security Association and Key Management Protocol (ISAKMP) phase 1 SA delete message for each phase 1 Security Association (SA) established prior to said reset; and
ii) means for transmitting said delete message to said one or more peer IKE nodes, whereby said peer IKE nodes delete each local phase 1 SA corresponding to each of said phase 1 SAs established prior to said reset.

9. The node recited in claim 8, wherein each of said ISAKMP delete messages is generated following said reset of said IKE node using SA data stored in said non-volatile memory prior to said reset.

10. The node recited in claim 8, wherein each of said ISAKMP delete messages is generated prior to said reset, and are stored in non-volatile memory for use following said reset.

11. The node recited in claim 8, further comprising means for periodically backing-up said phase 1 SA data in a non-volatile memory whereby said SA data is available to said IKE node following said reset.

12. The node recited in claim 11, wherein a crypto context for each phase 1 SA is also saved in said non-volatile memory.

13. The node recited in claim 8, wherein said IKE node is a security gateway of a Virtual Private Network (VPN).

14. The node recited in claim 8, wherein said IKE node is a node within a mobile telecommunications network and said peer IKE nodes are mobile terminals.
